(19) United States
(12) Patent Application Publication
(10) Pub. No.: US 2025/0069126 A1
(43) Pub. Date: Feb. 27, 2025

(54) RECOMMENDATION SYSTEM USING A RECIPE DATABASE AND CO-OCCURRENCES OF HISTORICAL ITEM SELECTIONS

(71) Applicant: Maplebear Inc., San Francisco, CA (US)

(72) Inventors: Madeline Mesard, New York, NY (US); Kevin McCullough, Austin, TX (US); Ryan Martin, Toronto (CA); Justin Park, Santa Barbara, CA (US)

(21) Appl. No.: 18/236,342

(22) Filed: Aug. 21, 2023

(51) Int. Cl. G06Q 30/0601; G06F 16/22; G06Q 10/087

(52) U.S. Cl. CPC G06Q 30/0623; G06F 16/2282; G06Q 10/087; G06Q 30/0631

(57) ABSTRACT

An online system identifies recipes that are most likely to be pertinent to particular users of the system. To do so, the online system uses an association table containing degrees of association between pairs of possible ingredients, identifying degrees of association between the constituent ingredients of various possible recipes and between ingredients from known user personalization data about the user to whom recipes are being recommended. These degrees of association are used to compute a score for each recipe as a whole, with the highest scores indicating the most pertinent recipes for the user in question. The most pertinent recipes, and/or the constituent ingredients of those recipes, are recommended to the user, and the system may additionally aid the user in obtaining the full complement of ingredients for a recommended recipe. The system may also build the association table as a co-occurrence graph of pairs of items that were previously purchased together by users of the system.

### BACKGROUND

Concierge systems, which enable assistants to provide assistance to a customer with the customer's errands or other personal business, are of value to both the assistants and the customers, providing the customers with the ability to accomplish tasks for which they lack the time or ability, and the assistants with flexible employment opportunities.

Some concierge systems facilitate assistants performing shopping for groceries or other food items on behalf of customers. Although the customers can thus obtain the food items that they desire, significant effort is still required to determine which items are required to prepare a particular meal, which meals would be easiest to prepare with the ingredients at hand, and the like.

### SUMMARY

In accordance with one or more aspects of the disclosure, an online concierge system identifies recipes that are most likely to be pertinent to particular users of the system. To do so, the online system uses an association table containing degrees of association between pairs of possible ingredients, identifying degrees of association between the constituent ingredients of various possible recipes and between ingredients from known user personalization data about the user to whom recipes are being recommended. These degrees of association are used to compute a score for each recipe as a whole, with the highest scores indicating the most pertinent recipes for the user in question. The most pertinent recipes, and/or the constituent ingredients of those recipes, are recommended to the user, and the system may additionally aid the user in obtaining the full complement of ingredients for a recommended recipe. The system may also build the association table as a co-occurrence graph of pairs of items that were previously purchased together by users of the system.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates components of the recipe analysis module of FIG. 2, according to some embodiments.

FIG. 4 illustrates steps performed by the recipe analysis module of FIG. 2 when identifying recipes most applicable to a user and helping the user to obtain all necessary items for the recipes, according to some embodiments.

FIG. 5 illustrates an example user interface for recommending recipes and obtaining missing ingredients, according to some embodiments.

### DETAILED DESCRIPTION

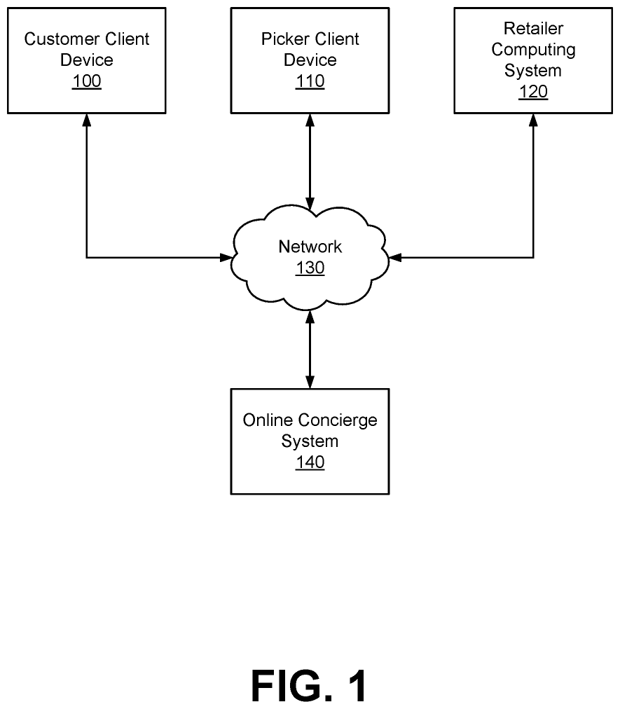

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker (also referred to as a “shopper”) that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

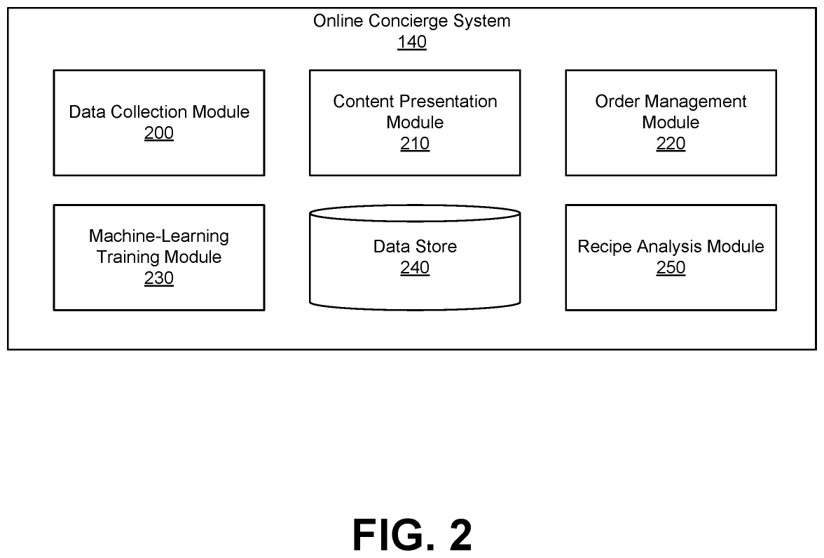

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The online concierge system 140 additionally includes a recipe analysis module 250 that performs analysis of user data in order to identify recipes that are most appropriate for the users and help the users to obtain the constituent items.

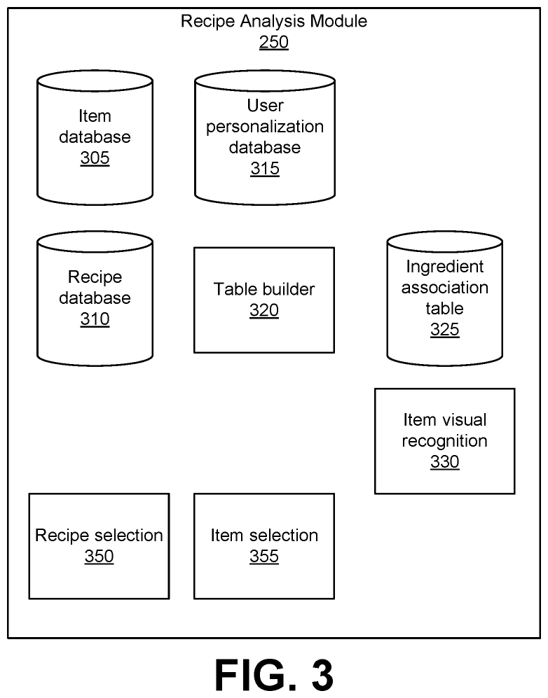

FIG. 3 illustrates components of the recipe analysis module 250, according to some embodiments.

The recipe analysis module 250 includes an item database 305 that contains identifiers of all the possible items that users can obtain through the online concierge system 140. In some embodiments, the item database 305 can have additional information about the items, such as their association with higher-level categories to which they belong (e.g., an item representing a particular brand or size of yogurt being associated with the more general category “yogurt”).

The recipe analysis module 250 further includes a recipe database 310 that stores a set of possible recipes. Each recipe in the recipe database 310 has an associated set of associated ingredients used to prepare the recipe. (The term “ingredient” is used herein to refer to an element of a recipe at any desired level of specificity, such as a highly specific product (e.g., including maker, size, quantity, or flavor of the product, such as “Dairy Delight Yogurt, cherry, 8 oz.”), or a more general category that abstracts away such specifics (e.g., “yogurt”).) The items in the item database 305 may be ingredients in some embodiments. The recipes may additionally have other associated data, such as instructions on how to prepare the recipe, images, or the like.

In some embodiments, the recipe database 310 is not static, but rather may be dynamically generated or added to using a transformer or other machine learning model that generates recipes based on information known about the user, such as ingredients that the user tends to buy, the total calories or other nutritive properties of the recipes and the user's health goals, etc.

The recipe analysis module 250 further includes a user personalization database 315 that stores user personalization data associated with the various users of the online concierge system 140, which acts as a basis for determining which recipes are most likely to be appropriate for which users. The various types of user personalization data can vary in different embodiments, including (but not limited to) identifiers of ingredients that the user has previously purchased over some prior time period, identifiers of ingredients currently in the user's shopping list on the online concierge system 140, and/or identifiers of ingredients that the user presently has within his or her possession, such as within a refrigerator, freezer, or other food refrigeration or storage unit, within a kitchen or pantry or other storage area, or the like. Collectively, the identifiers pertain to ingredients which the user has interacted with in some manner, such as purchasing, placing in a shopping cart, or having in her possession. (A more general “ingredient” covers a more specific item. For example, if a user had purchased a specific flavor of yogurt, and the ingredient in a recipe is the more general “yogurt”, then the user personalization database 315 may store that the user purchased the ingredient “yogurt.”)

The recipe analysis module 250 further includes a table builder module 320 that creates an ingredient association table 325 analyzing the relationships of the various possible items in the item database 305. The association table 325 can then be used to determine which recipes would be most appropriate for which users.

The association table 325, as generated by the table builder module 320, contains degrees of association for all or some of the possible unordered pairs of recipe ingredients. (As noted above, in various embodiments the recipe ingredients can be expressed at the level of specific items, or as a more general category.) Table 1, below, illustrates a sample subset of the association table 325; for example, the association score for the pair <Rutabaga, Turnips> is 0.987652. In some embodiments, the association table 325 contains a full N×N entries (the pairs for N possible ingredients). As a skilled practitioner would recognize, the association table 325 may be represented in different manners, such as with a three column table, with one column for each ingredient, and one column for the score associated with the ingredient pair represented by that row.

TABLE 1

| | Tur- | Pickled | Pizza | Jelly | Pizza | |
|---|---|---|---|---|---|---|
| | nips | ginger | sauce | beans | crust | . . . |
| Ruta- | 0.987652 | 0.389388 | −0.38773 | −0.37374 | 0.083773 | |
| baga | | | | | | |
| Wasabi | 0.678383 | 0.982834 | 0.189387 | −0.893733 | 0.183898 | |
| Chayote | 0.389838 | 0.738928 | −0.43273 | −0.704001 | −0.28383 | |
| squash | | | | | | |
| Break- | 0.378373 | −0.65789 | 0.673722 | 0.238783 | 0.483737 | |
| fast | | | | | | |
| sausage | | | | | | |
| Eclairs | −0.38893 | 0.183747 | 0.38373 | 0.837737 | 0.289373 | |
| . . . | | | | | | |

The degree of association for a given pair of ingredients represents the frequency with which the ingredients tend to be used together. In some embodiments, the degree of association is defined historically, based on whether (or to what extent) the pair of ingredients co-occurs in prior orders of users. In one particular embodiment, for example, the degree of association is defined as (AB*¬A¬B-A¬B*¬AB)/(AB*¬A¬B+A¬B*¬AB) (also known as the statistical measure, Yule's Q), where “A” and “B” represent the first and second ingredients of the pair, respectively, and where AB represents the number of users (or, in some embodiments, households or other related groups of users) satisfying some criterion with respect to both ingredients A and B, ¬AB represents the number of users who satisfy the criterion with respect to ingredient B but not ingredient A, A¬B represents the number of users who satisfy the criterion with respect to ingredient A but not ingredient B, and ¬A¬B represents the number of users who satisfy the criterion neither with respect to ingredient A nor with respect to ingredient B. For example, in various embodiments the criterion can be whether a user purchased the given ingredient during some time range (e.g., the last month), or whether a user purchased both ingredients within the same order, or within at least a particular percentage of the orders. Note that this definition of the degree of association normalizes the degree to the range [−1.0, 1.0], with positive values indicating that the two ingredients tend to satisfy the criterion more frequently than not (e.g., the ingredients may be interchangeable, or used often together, or indicative of a particular dietary preference). Thus, for example, in some embodiments “AB” represents the number of households that bought ingredient A at some point during a given time period, and also bought ingredient B at some point during that time period. In other embodiments, the degree of association is defined to quantify number of purchases (e.g., the total number of times that the given pair of ingredients was bought together, aggregated over all users).

In some embodiments, the table builder module 320 rebuilds the association table 325 in response to certain conditions, such as the passing of a certain amount of time, the accumulation of a given amount of additional orders, or the like. In this way, the association table 325 reflects up-to-date information.

In some embodiments, the recipe analysis module 250 further includes an item visual recognition module 330 that identifies items that the user presently has within his or her possession. (These identified items then can constitute part of the data of user personalization database 315 for that user.) The item visual recognition module 330 inputs a digital file with image data, such as a single digital image, a video (containing or conceptually containing multiple images), or the like, and performs image recognition of the image(s) to identify items/ingredients. For example, a user could send an image or video of the inside of the user's refrigerator, freezer, pantry, or other food storage unit, to the item visual recognition module 330 (e.g., via an “Upload photo” button within a graphical user interface of an application on the customer client device 100 for using the online concierge system 140), and the recipe analysis module 250 could then add the resulting identified items to the user personalization database 315 in association with that user.

The recipe analysis module 250 further includes a recipe selection module 350 that takes the ingredient association table 325 and the user-specific user personalization database 315 as input, and using that information selects one or more recipes that are most likely to be relevant to a given user. In some embodiments, the recipe analysis module 250 computes a score for each recipe within some set of recipes (e.g., all recipes) within the recipe database 310 and selects the top N highest-scoring recipes (e.g., N=1). Pseudocode for the selection process for computing a score for the recipes for a user u according to some embodiments is as follows:

```
For each recipe R:
  For every ingredient rⱼ in R:
    For every ingredient pᵢ in u's personalization database data:
      vᵢ = AssociationTableLookup(rⱼ, pᵢ)
    rⱼ.score = max(v)
  R.score = normalize(Σ r.score)
```

That is, for each of the recipes, and for every ingredient of the recipe, the degrees of association between the ingredient and each of the various ingredients in the user personalization database 315 are looked up within the ingredient association table 325, and the highest degree of association (that is, the highest association between that particular recipe ingredient and the ingredients in the user's personalization data) is selected. Then, for each recipe, the score for the recipe is the normalized sum of the scores. (Normalization may be achieved, e.g., by dividing by the number of ingredients in the recipe.) In some embodiments, the association measure vi is weighted based on the particular source of data in the user personalization database 315. For example, in some embodiments an ingredient in the user personalization database 315 whose source was the user's shopping list would receive a weighting of 1.0, while ingredients whose source was a previously-purchased item would receive a weighting of 0.7, and ingredients whose source was an image analyzed by the item visual recognition module 330 would receive a weighting of 0.5.

The recipe analysis module 250 may then cause the selected recipe(s) to be presented to the user for the user's consideration, such as within a graphical user interface of an application on the customer client device 100.

In some embodiments, the recipe analysis module 250 has an item selection module 355 that simplifies the process for the user to obtain all the ingredients for a given recipe, such as a recipe selected by the recipe analysis module 250 and accepted by the user. For example, in some embodiments the recipe analysis module 250 identifies ingredients of the recipe that the user already has in her possession (e.g., those identified by the item visual recognition module 330) or that are already within her shopping list, and offers to automatically obtain the remaining ingredients. (For example, the item selection module 355 could cause display of the message “Chicken fajitas with peppers is a healthy meal, and you already have 5 of its ingredients in your cart. Would you like to add the rest of the ingredients to your shopping list?” and allow the user to approve or deny the offer (either as a whole, or for individual items), automatically adding items for those ingredients to the user's shopping list if the user approves.)

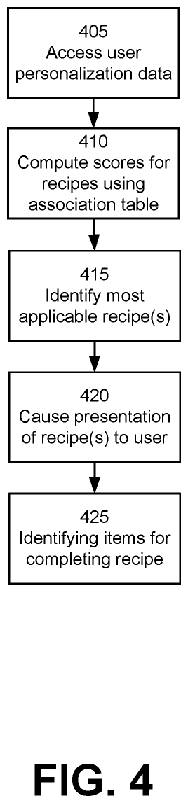

FIG. 4 illustrates steps performed by the recipe analysis module 250 when identifying recipes most applicable to a user and helping the user to obtain all necessary items for the recipes, according to some embodiments.

In step 405, the recipe analysis module 250 accesses data from user personalization database 315, such as identifiers of items/ingredients that the user has previously purchased or placed on his shopping list, or which are automatically identified within images (e.g., images of refrigerator contents) using machine-learned models to perform object recognition.

In step 410 the recipe analysis module 250 computes scores for recipes using the (previously generated) ingredient association table 325, as discussed above with respect to the recipe selection module 350.

In step 415, the recipe analysis module 250 identifies the recipe(s) most applicable to the user by selecting the recipe(s) with the highest recipe scores of those computed in step 410.

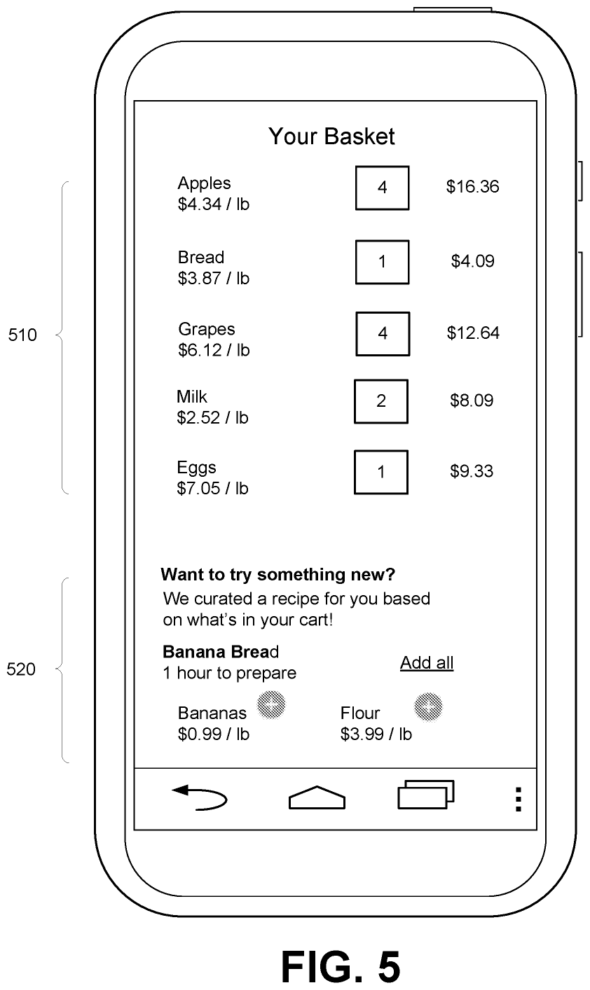

In step 420, the recipe analysis module 250 causes presentation of the identified recipes to the user. For example, the recipe analysis module 250 can send instructions to an application on the customer client device 100 for interacting with the online concierge system 140, and the application can accordingly display the identified recipes within its graphical user interface. (One example user interface is illustrated in FIG. 5. Area 510 of the user interface displays the items already in the basket of the current user-namely, apples, bread, grapes, milk, and eggs. Area 520 displays selected recipes selected for the user (banana bread, in this example, given that the user already has several of the necessary ingredients in his basket), and also recipe ingredients that the user does not already have in his basket (namely, bananas and flour), along with user interface elements facilitating purchasing those items (e.g., the “+” icons allowing addition of the ingredients individually, and the “Add all” link for adding all of the missing ingredients in a single action).

In step 425, the recipe analysis module 250 identifies items for completing one of the recipes (e.g., one of the identified recipes accepted by the user), as described above with respect to the item selection module 355. The recipe analysis module 250 may further add those items to the user's shopping cart, such as in response to the user approving those items. In some embodiments, the recipe analysis module 250 updates the user personalization database 315 to reflect the user's interactions with the recipes suggested by the recipe selection module 350 (such as selecting, or rejecting, those recipes), or with the items suggested by the item selection module 355 (such as approving or rejecting the automatic addition of those items to the user's basket). This information can be used in by the recipe selection module 350 when making future recipe recommendations to the user.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method performed at a computer system comprising a processor and a computer-readable medium, the method comprising:
accessing user personalization data associated with a user, the user personalization data comprising identifiers of a set of items with which the user interacted;
for each recipe of a set of recipes:
accessing an association table that stores degrees of association between pairs of items;
for each of a set of items of the recipe, obtaining a degree of association between the item and an item of the user personalization data from the association table;
computing a score for the recipe using the degrees of association;
selecting a recipe from the set of recipes based on the scores computed for the recipes; and
causing presentation of the selected recipe by a device associated with the user in a graphical user interface of the device.

2. The method of claim 1, wherein the user personalization data comprises identifiers of items currently within a shopping list of the user.

3. The method of claim 1, wherein the user personalization data comprises identifiers of items previously purchased by the user.

4. The method of claim 1, wherein the user personalization data comprises identifiers of items within a food storage unit of the user.

5. The method of claim 4, further comprising:
receiving an image of contents of the food storage unit; and
performing image analysis of the image using a machine-learned model to identify the items within the food storage unit.

6. The method of claim 1, further comprising:
identifying a set of items currently in a shopping list of the user;
identifying items used by the recipe that are not already present in the set of items currently in the shopping list; and
causing display to the user of the identified items used by the recipe that are not already present in the set of items currently in the shopping list.

7. The method of claim 6, further comprising placing, within the shopping list of the user, at least some of the identified items used by the recipe that are not already present in the set of items currently in the shopping list.

8. The method of claim 1, further comprising generating the association table, the generating comprising:
identifying orders of a plurality of users over a given period of time; and
computing, as an association degree in the association table for a first item and a second item, a co-occurrence measure for the first item and the second item evaluated over the identified orders of the plurality of users.

9. The method of claim 8, wherein the user personalization data comprise identifiers of a set of items that the user has purchased during the given period of time.

10. The method of claim 8, wherein the co-occurrence measure for the first item and the second item is defined as (AB*¬A¬B-A¬B*¬AB)/(AB*¬A¬B+A¬B*¬AB), where A represents the first item and B represents the second item.

11. A non-transitory computer-readable storage medium containing instructions that when executed by one or more processors perform actions comprising:
accessing user personalization data associated with a user, the user personalization data comprising identifiers of a set of items with which the user interacted;
for each recipe of a set of recipes:
accessing an association table that stores degrees of association between pairs of items;
for each of a set of items of the recipe, obtaining a degree of association between the item and an item of the user personalization data from the association table;
computing a score for the recipe using the degrees of association;
selecting a recipe from the set of recipes based on the scores computed for the recipes; and
causing presentation of the selected recipe by a device associated with the user in a graphical user interface of the device.

12. The non-transitory computer-readable storage medium of claim 11, wherein the user personalization data comprise identifiers of items currently within a shopping list of the user.

13. The non-transitory computer-readable storage medium of claim 11, wherein the user personalization data comprise identifiers of a set of items that the user has purchased during the given period of time.

14. The non-transitory computer-readable storage medium of claim 11, wherein the user personalization data comprise identifiers of items within a food storage unit of the user.

15. The non-transitory computer-readable storage medium of claim 14, the actions further comprising:
receiving an image of contents of the food storage unit; and
performing image analysis of the image using a machine-learned model to identify the items within the food storage unit.

16. The non-transitory computer-readable storage medium of claim 11, the actions further comprising:
identifying a set of items currently in a shopping list of the user;
identifying items used by the recipe that are not already present in the set of items currently in the shopping list; and
causing display to the user of the identified items used by the recipe that are not already present in the set of items currently in the shopping list.

17. The non-transitory computer-readable storage medium of claim 16, the actions further comprising placing, within the shopping list of the user, at least some of the identified items used by the recipe that are not already present in the set of items currently in the shopping list.

18. The non-transitory computer-readable storage medium of claim 11, the actions further comprising generating the association table, the generating comprising:
identifying orders of a plurality of users over a given period of time; and
computing, as an association degree in the association table for a first item and a second item, a co-occurrence measure for the first item and the second item evaluated over the identified orders of the plurality of users.

19. The non-transitory computer-readable storage medium of claim 18, wherein the co-occurrence measure for the first item and the second item is defined as (AB*¬A¬B-A¬B*¬AB)/(AB*¬A¬B+A¬B*¬AB), where A represents the first item and B represents the second item.

20. A computer system comprising:
one or more computer processors; and
a computer-readable storage medium storing instructions that when executed by the one or more computer processors perform actions comprising:
accessing user personalization data associated with a user, the user personalization data comprising identifiers of a set of items with which the user interacted;
for each recipe of a set of recipes:
accessing an association table that stores degrees of association between pairs of items;
for each of a set of items of the recipe, obtaining a degree of association between the item and an item of the user personalization data from the association table;
computing a score for the recipe using the degrees of association;
selecting a recipe from the set of recipes based on the scores computed for the recipes; and
causing presentation of the selected recipe by a device associated with the user in a graphical user interface of the device.
